(19) United States
(12) Patent Application Publication
(10) Pub. No.: US 2016/0104088 A1
(43) Pub. Date: Apr. 14, 2016

(54) DEMAND-SUPPLY ADJUSTING DEVICE AND DEMAND-SUPPLY CONDITION CONSOLIDATING METHOD

(71) Applicant: HITACHI SOLUTIONS, LTD., Tokyo (JP)

(72) Inventors: Junko HOSODA, Tokyo (JP); Yuuichi TERAZAKI, Tokyo (JP); Tazu NOMOTO, Tokyo (JP)

(73) Assignee: HITACHI SOLUTIONS, LTD., Tokyo (JP)

(21) Appl. No.: 14/792,854

(22) Filed: Jul. 7, 2015

(30) Foreign Application Priority Data
Oct. 9, 2014 (JP) 2014-207820

(51) Int. Cl. G06Q 10/06

(52) U.S. Cl. CPC G06Q 10/06315

(57) ABSTRACT

A logistics network that is optimum under consolidated demand-supply conditions is obtained. A demand-supply information storing unit stores demand-supply information about demand and supply. A similarity degree calculating unit calculates a degree of similarity between items that are included in the demand-supply information. A grouping unit groups together the items included in the demand-supply information together, based on the degree of similarity. An impact degree calculating unit calculates, for items that are grouped by the grouping unit and for items that are not grouped by the grouping unit, the degrees of impact of the items on demand-supply conditions to be used in processing of searching for an optimum logistics network. A determining unit determines, based on the degrees of impact calculated by the impact degree calculating unit, whether or not the demand-supply conditions of the items are to be used in the logistics network search processing.

### BACKGROUND OF THE INVENTION

The present invention relates to a demand-supply adjusting device and a demand-supply condition consolidating method. The present invention claims priority to Japanese Patent Application No. 2014-207820 filed on Oct. 9, 2014, the contents of which are incorporated herein by reference in its entirety for the designated states where incorporation by reference of literature is allowed.

In Japanese Patent Laid-open Publication No. 2012-14372, there is disclosed an information processing device configured to assist in the optimization of a logistics network with the use of demand data and supply data of an article, the information processing device including: first storing means for storing cost data about expenses necessary to transport the article; first setting means for setting demand data of the article at each of a plurality of demand bases in the logistics network; second setting means for setting supply data of the article at each of a plurality of supply bases in the logistics network; optimizing means for deriving, with the use of the cost data, the demand data, and the supply data, an optimum logistics network that is a logistics network where expenses necessary to transport the article are minimum; and stock simulation means for simulating, in time series, the article's transitions in demand at important bases in the optimum logistics network and in supply at the supply bases in the optimum logistics network.

In Japanese Patent Laid-open Publication No. 2012-14372, conditions of cost data, demand data, and the like that are to be used in a search for an optimum logistics network are grouped and consolidated to reduce the conditions in number in an attempt to improve calculation efficiency. An optimum logistics network obtained under grouped and consolidated conditions may consequently not fulfill some of original conditions before the consolidation, and a simulation for determining whether or not an optimum logistics network obtained under consolidated conditions fulfills pre-consolidation conditions is therefore executed in Japanese Patent Laid-open Publication No. 2012-14372.

In other words, Japanese Patent Laid-open Publication No. 2012-14372 involves checking by simulation whether or not an obtained optimum logistics network is an implementable optimum logistics network that fulfills pre-consolidation conditions, and has a possibility in that the search fails to pick up an optimum logistics network that fulfills pre-consolidation demand-supply conditions.

### SUMMARY OF THE INVENTION

The present invention therefore provides a technology of consolidating demand-supply conditions in a manner that ensures a search where an optimum logistics network that fulfills demand-supply conditions before the consolidation is not missed.

This application includes a plurality of means for solving at least a part of the above-mentioned problem, an example of which is as follows. In order to solve the above-mentioned problem, according to one embodiment of the present invention, there is provided a demand-supply adjusting device, including: a demand-supply information storing unit configured to store demand-supply information about demand and supply; a similarity degree calculating unit configured to calculate a degree of similarity between items that are included in the demand-supply information stored in the demand-supply information storing unit; a grouping unit configured to group the items included in the demand-supply information together, based on the degree of similarity calculated by the similarity degree calculating unit; an impact degree calculating unit configured to calculate, for items that are grouped by the grouping unit and for items that are not grouped by the grouping unit, degrees of impact of the items on demand-supply conditions to be used in processing of searching for an optimum logistics network; and a determining unit configured to determine, based on the degrees of impact calculated by the impact degree calculating unit, whether or not the demand-supply conditions of the items are to be used in the logistics network search processing.

According to one embodiment of the present invention, the optimum logistics network can be obtained under the demand-supply conditions that have been consolidated. Other objects, configurations, and effects than those described above are clarified in the following description of an embodiment.

### BRIEF DESCRIPTION OF THE DRAWINGS

FIG. 1 is a diagram illustrating a function block configuration example of a demand-supply adjusting device 1 according to an embodiment of the present invention.

FIG. 2 is a diagram showing a data configuration example of a demand information storing unit 21.

FIG. 3 is a diagram showing a data configuration example of a supply lead time information storing unit 22.

FIG. 4 is a diagram showing a data configuration example of a unit purchase price information storing unit 23.

FIG. 5 is a diagram showing a data configuration example of a unit manufacturing cost information storing unit 24.

FIG. 6 is a diagram showing a data configuration example of a factory load information storing unit 25.

FIG. 7 is a diagram showing a data configuration example of a production capacity information storing unit 26.

FIG. 8 is a diagram showing a data configuration example of an initial stock information storing unit 27.

FIG. 9 is a diagram showing a data configuration example of a similarity degree calculation rule information storing unit 31.

FIG. 10 is a diagram showing a data configuration example of an impact degree calculation rule information storing unit 32.

FIG. 11 is a diagram showing a data configuration example of an article similarity degree information storing unit 33.

FIG. 12 is a diagram showing a data configuration example of an impact degree information storing unit 34.

FIG. 13 is a flow chart illustrating an operation example of the demand-supply adjusting device 1.

FIG. 14 is a diagram illustrating an example of a screen that displays the result of determination performed by a determining unit 15.

FIG. 15 is a diagram illustrating an example of a screen that displays a logistics network found by a demand-supply adjusting unit 16 and flow volumes calculated by the demand-supply adjusting unit 16.

FIG. 16 is a diagram illustrating a hardware configuration example of the demand-supply adjusting device 1.

### DESCRIPTION OF THE PREFERRED EMBODIMENT

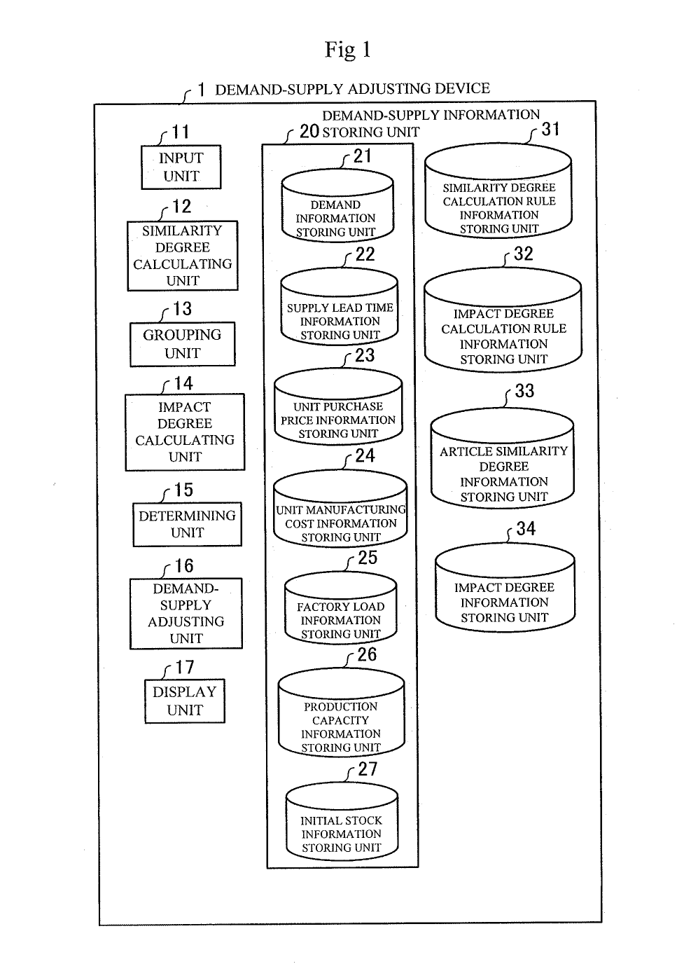

FIG. 1 is a diagram illustrating a function block configuration example of a demand-supply adjusting device 1 according to an embodiment of the present invention. The demand-supply adjusting device 1 of FIG. 1 is implemented by an information processing device such as a server or a personal computer (PC). The demand-supply adjusting device 1 receives demand-supply information about the demand and supply of a part, a product, or the like from a user, and searches for an optimum logistics network that leads from a supply base of the part, the product, or the like to a demand base of the part, the product, or the like.

The demand-supply adjusting device 1 includes an input unit 11, a similarity degree calculating unit 12, a grouping unit 13, an impact degree calculating unit 14, a determining unit 15, a demand-supply adjusting unit 16, a display unit 17, a demand-supply information storing unit 20, a similarity degree calculation rule information storing unit 31, an impact degree calculation rule information storing unit 32, an article similarity degree information storing unit 33, and an impact degree information storing unit 34.

The input unit 11 receives an input of demand-supply information about demand and supply, which is made by a user. The input unit 11 stores the user's input of demand-supply information in the demand-supply information storing unit 20. The input unit 11 also receives an input of information about the calculation of the degree of similarity, which is made by the user. The input unit 11 stores the user's input of information about similarity degree calculation in the similarity degree calculation rule information storing unit 31. The input unit 11 also receives an input of information about the calculation of the degree of impact, which is made by the user. The input unit 11 stores the user's input of information about impact degree calculation in the impact degree calculation rule information storing unit 32.

The similarity degree calculating unit 12 calculates the degree of similarity between items that are included in the supply-demand information stored in the supply-demand information storing unit 20. Items for which the degree of similarity is calculated include, for example, articles (parts, products, and the like) distributed over logistics networks, and supply or manufacturing bases of an article. More specifically, the similarity degree calculating unit 12 calculates how similar Part A and Part B, which are supplied from suppliers, are to each other.

The grouping unit 13 groups items that are included in the demand-supply information, based on the degree of similarity calculated by the similarity degree calculating unit 12. For example, when the degree of similarity between items calculated by the similarity degree calculating unit 12 exceeds a given threshold, the grouping unit 13 determines that the items are similar to each other and groups the items together. More specifically, when the degree of similarity between Part A and Part B calculated by the similarity degree calculating unit 12 exceeds a given threshold, the grouping unit 13 determines that Part A and Part B are similar to each other, and groups Part A and Part B together (consolidates Parts A and B as one part). In the following description, the grouped Parts A and B are referred to as Parts A&B group.

The impact degree calculating unit 14 calculates the degrees of impact of items that are grouped by the grouping unit 13 and items that are not grouped by the grouping unit 13 on demand-supply conditions to be used in processing of searching for an optimum logistics network. For instance, the impact degree calculating unit 14 calculates the degrees of impact of the Parts A&B group, which is created through grouping by the grouping unit 13, and a part that is not grouped by the grouping unit 13 (e.g., Part C) on demand-supply conditions.

The determining unit 15 determines, based on the degrees of impact calculated by the impact degree calculating unit 14, for items grouped by the grouping unit 13 and for items that are not grouped by the grouping unit 13, whether or not demand-supply conditions of the items are to be used in logistics network search processing (whether to be counted in as subjects of calculation for logistics network search processing). For example, when the degrees of impact of grouped items and ungrouped items on demand-supply conditions exceed a given threshold, the determining unit 15 determines that demand-supply conditions of the items are to be used in the logistics network search processing. More specifically, when the degree of impact of the Parts A&B group, which is created by grouping, does not exceed a given threshold whereas the degree of impact of Part C exceeds the given threshold, the determining unit 15 determines that demand-supply conditions of the Parts A&B group, which is created by grouping, are not to be used in the logistics network search processing, and determines that demand-supply conditions of Part C, which is not grouped, are to be used in the logistics network search processing.

The demand-supply adjusting unit 16 searches for an optimum logistics network with the use of the supply-demand conditions determined by the determining unit 15 as conditions to be used in the logistics network search processing, and calculates the flow volume in the found logistics network. For example, the demand-supply adjusting unit 16 uses mixed integer programming, material requirements planning, or other methods to calculate an optimum logistics network that fulfills the supply-demand conditions determined by the determining unit 15 as conditions to be used in the logistics network search processing, and to calculate the flow volume in the optimum logistics network.

The display unit 17 displays on a display device the logistics network calculated by the demand-supply adjusting unit 16 and the flow volume of parts, products, and the like in this logistics network. The display unit 17 also displays on the display device the result of the determination performed by the determining unit 15.

The demand-supply information storing unit 20 stores demand-supply information about demand and supply, which is input by the user. The demand-supply information storing unit 20 includes a demand information storing unit 21, a supply lead time information storing unit 22, a unit purchase price information storing unit 23, a unit manufacturing cost information storing unit 24, a factory load information storing unit 25, a production capacity information storing unit 26, and an initial stock information storing unit 27.

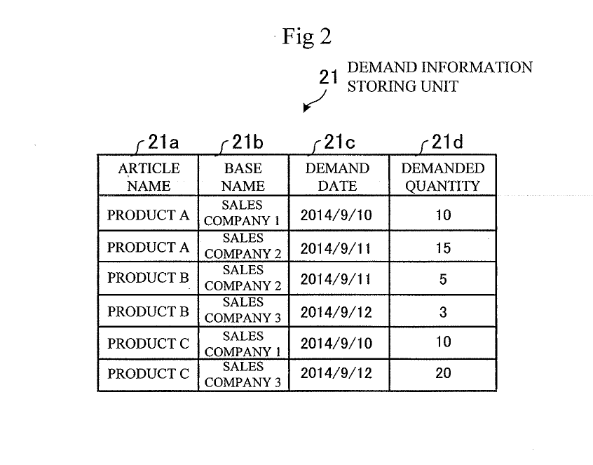

FIG. 2 is a diagram showing a data configuration example of the demand information storing unit 21. The demand information storing unit 21 stores information about the demand for a product, which is input by the user. The demand information storing unit 21 stores in each entry an article name 21a, a base name 21b, a demand date 21c, and a demanded quantity 21d.

The article name 21a in an entry is the name of a product (article) demanded by a customer.

The base name 21b is the name of a demand base of the product that is indicated by the article name 21a of the entry in question.

The demand date 21c is the demand date of the product that is indicated by the article name 21a of the entry in question.

The demanded quantity 21d is the demanded quantity of the product that is indicated by the article name 21a of the entry in question.

In the example of FIG. 2, a product whose article name 21a is “Product A” is demanded by a sales company whose base name 21b is “Sales Company 1” to be delivered in a quantity of “10” as indicated by the demanded quantity 21d, by “Sep. 10, 2014” as indicated by the demand date 21c.

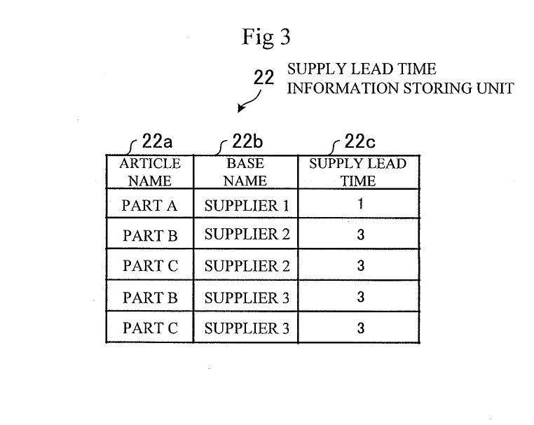

FIG. 3 is a diagram showing a data configuration example of the supply lead time information storing unit 22. The supply lead time information storing unit 22 stores information about the supply lead time of a part, which is input by the user. The supply lead time information storing unit 22 stores in each entry an article name 22a, a base name 22b, and a supply lead time 22c.

The article name 22a in an entry is the name of a part (article) supplied by a supplier. Parts supplied by suppliers are, for example, parts that form the products of FIG. 2.

The base name 22b is the name of the supplier who supplies the part that is indicated by the article name 22a of the entry in question.

The supply lead time 22c is the supply lead time of the part that is indicated by the article name 22a of the entry in question.

In the example of FIG. 3, a part whose article name 22a is “Part A” is supplied, when ordered from a supplier whose base name 22b is “Supplier 1”, in a lead time of “1” as indicated by the supply lead time 22c.

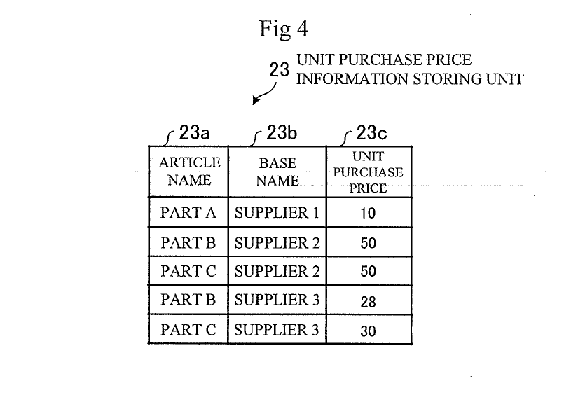

FIG. 4 is a diagram showing a data configuration example of the unit purchase price information storing unit 23. The unit purchase price information storing unit 23 stores information about the unit purchase price of a part, which is input by the user. The unit purchase price information storing unit 23 stores in each entry an article name 23a, a base name 23b, and a unit purchase price 23c.

The article name 23a in an entry is the name of a part supplied by a supplier.

The base name 23b is the name of the supplier who supplies the part that is indicated by the article name 23a of the entry in question.

The unit purchase price 23c is the unit purchase price of the part that is indicated by the article name 23a of the entry in question.

In the example of FIG. 4, a part whose article name 23a is “Part A” is supplied by a supplier whose base name 23b is “Supplier 1” at a unit purchase price of “10” as indicated by the unit purchase price 23c.

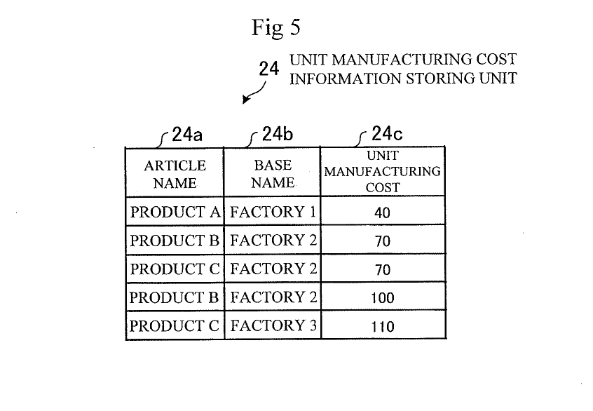

FIG. 5 is a diagram showing a data configuration example of the unit manufacturing cost information storing unit 24. The unit manufacturing cost information storing unit 24 stores information about the unit manufacturing cost of a product, which is input by the user. The unit manufacturing cost information storing unit 24 stores in each entry an article name 24a, a base name 24b, and a unit manufacturing cost 24c.

The article name 24a in an entry is the name of a product manufactured in a factory.

The base name 24b is the name of a base of a factory where the product that is indicated by the article name 24a of the entry in question is manufactured.

The unit manufacturing cost 24c is the unit manufacturing cost of the product that is indicated by the article name 24a of the entry in question.

In the example of FIG. 5, apart whose article name 24a is “Product A” is manufactured by a factory whose base name 24b is “Factory 1” at a unit manufacturing cost of “40” as indicated by the unit manufacturing cost 24c.

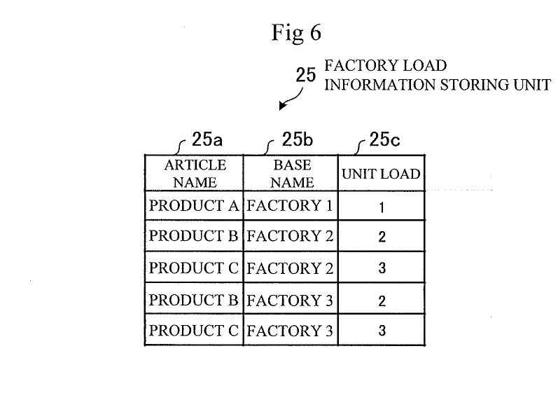

FIG. 6 is a diagram showing a data configuration example of the factory load information storing unit 25. The factory load information storing unit 25 stores information about a unit load of the product manufactured by the factory, which is input by the user. The factory load information storing unit 25 stores in each entry an article name 25a, a base name 25b, and a unit load 25c.

The article name 25a in an entry is the name of a product manufactured by a factory.

The base name 25b is the name of a base of a factory where the product that is indicated by the article name 25a of the entry in question is manufactured.

The unit load 25c is a unit load applied in the manufacture of the product that is indicated by the article name 25a of the entry in question.

In the example of FIG. 6, a product whose article name 25a is “Product A” is manufactured by a factory whose base name 25b is “Factory 1” at a unit load of “1” as indicated by the unit load 25c.

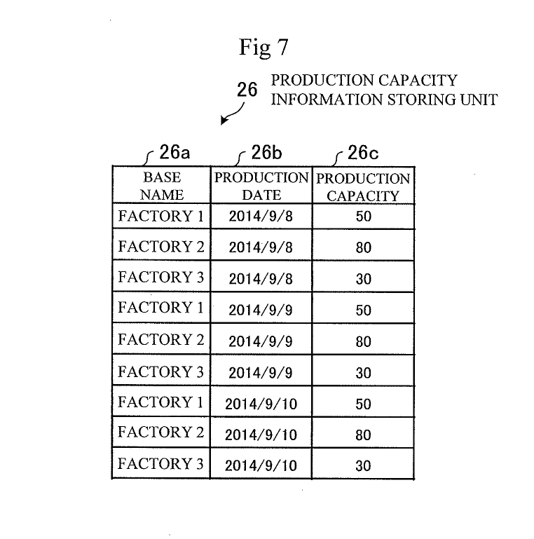

FIG. 7 is a diagram showing a data configuration example of the production capacity information storing unit 26. The production capacity information storing unit 26 stores information about the production capacity of a factory, which is input by the user. The production capacity information storing unit 26 stores in each entry a base name 26a, a production date 26b, and a production capacity 26c.

The base name 26a in an entry is the name of a base of a factory where a product is produced.

The production date 26b is a production date when the product is produced in the factory that is indicated by the base name 26a of the entry in question.

The production capacity 26c is the capacity of the factory that is indicated by the base name 26a of the entry in question to produce the product.

In the example of FIG. 7, a factory whose base name 26a is “Factory 1” has a production capacity of “50” as indicated by the production capacity 26c on “Sep. 8, 2014” as indicated by the production date 26b.

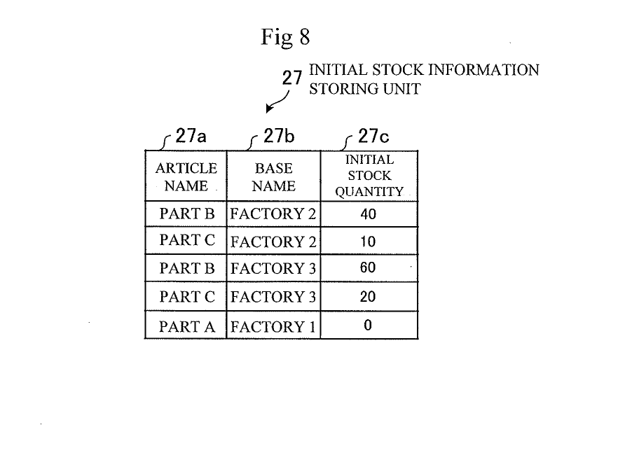

FIG. 8 is a diagram showing a data configuration example of the initial stock information storing unit 27. The initial stock information storing unit 27 stores information about the initial stock of a part of a factory, which is input by the user. The initial stock information storing unit 27 stores in each entry an article name 27a, a base name 27b, and an initial stock quantity 27c.

The article name 27a in an entry is the name of a part forming a product.

The base name 27b is the name of a base of a factory where the product is manufactured with the use of the part that is indicated by the article name 27a of the entry in question.

The initial stock quantity 27c is the initial stock quantity of the part that is indicated by the article name 27a of the entry in question at the factory that is indicated by the base name 27b of the entry in question.

In the example of FIG. 8, the initial stock quantity 27c of a part whose article name 27a is “Part B” is “40” at a factory whose base name 27b is “Factory 2”.

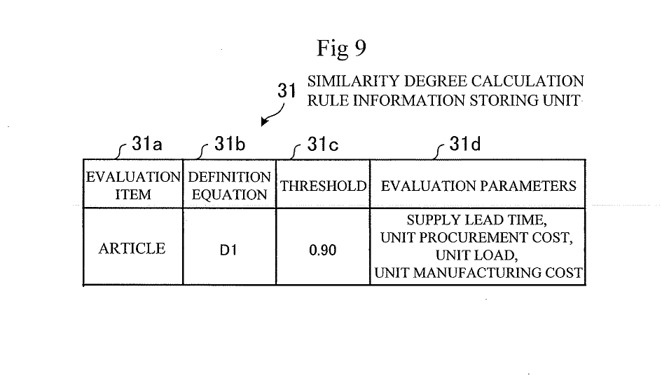

FIG. 9 is a diagram showing a data configuration example of the similarity degree calculation rule information storing unit 31. The similarity degree calculation rule information storing unit 31 stores information about the calculation of the degree of similarity between items that are included in the demand-supply information stored in the demand-supply information storing unit 20. The information about similarity degree calculation is input by the user to be stored in the similarity degree calculation rule information storing unit 31. The similarity degree calculation rule information storing unit 31 stores in each entry an evaluation item 31a, a definition equation 31b, a threshold 31c, and evaluation parameters 31d.

The evaluation item 31a is an item for which the degree of similarity is calculated. In the example of FIG. 9, articles (parts and products) are items of the similarity degree calculation.

The definition equation 31b is a calculus equation used by the similarity degree calculating unit 12 to calculate the degree of similarity between items. The definition equation 31b (D1) is expressed by Expression (1).

$$\begin{matrix}[ Expression 1 ] & \\ D 1 = 1 - \frac{\sqrt{{\sum }_{base} \frac{{( \begin{matrix}Article 1 evaluation value - \\ Article 2 evaluation value\end{matrix} )}^{2}}{{( max \{ \begin{matrix}Article 1 evaluation value , \\ Article 2 evaluation value\end{matrix} \} )}^{2}}}}{basecount} & ( 1 )\end{matrix}$$

Details of Expression (1) are described below.

The threshold 31c is a threshold that the grouping unit 13 uses to determine whether or not items are to be grouped together based on the degree of similarity calculated by the similarity degree calculating unit 12. For example, when the degree of similarity between Parts A and B calculated by the similarity degree calculating unit 12 exceeds a threshold “0.90”, the grouping unit 13 determines that Parts A and B are similar to each other and groups Parts A and B together.

The evaluation parameters 31d indicate viewpoints from which the degree of similarity is calculated for the evaluation item 31a. In the example of FIG. 9, the evaluation parameters 31d have values “supply lead time”, “unit procurement cost”, “unit load”, and “unit manufacturing cost”. The similarity degree calculating unit 12 therefore calculates the degree of similarity between articles from the viewpoint of, for example, supply lead time. The similarity degree calculating unit 12 calculates the degree of similarity between articles also from the viewpoint of unit procurement cost. The similarity degree calculating unit 12 calculates the degree of similarity between articles also from the viewpoint of unit load. The similarity degree calculating unit 12 calculates the degree of similarity between articles also from the viewpoint of unit manufacturing cost.

The degree of similarity calculated by Expression (1) is different for each evaluation parameter 31d in some cases and is the same for every evaluation parameter 31d in other cases. For example, Part A and Part B may be similar to each other from the viewpoint of supply lead time but may not from the viewpoint of unit procurement cost.

The grouping unit 13 groups items together when the degree of similarity between items exceeds the threshold 31c in every evaluation parameter 31d. For example, when the degree of similarity between Parts A and B exceeds “0.90” in each of supply lead time, unit procurement cost, unit load, and unit manufacturing cost, the grouping unit 13 groups Parts A and B together.

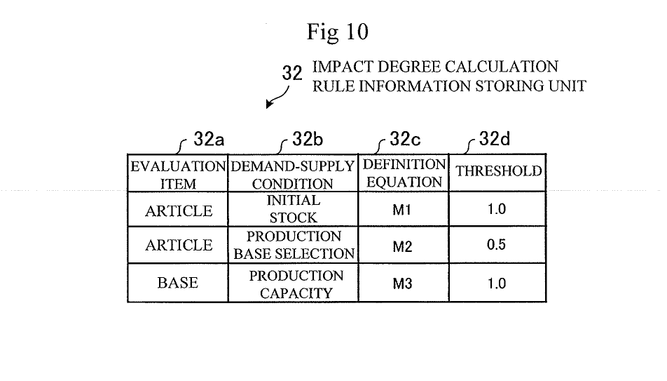

FIG. 10 is a diagram showing a data configuration example of the impact degree calculation rule information storing unit 32. The impact degree calculation rule information storing unit 32 stores information that is used by the impact degree calculating unit 14 to calculate the degree of impact. The information for calculating the degree of impact is input by the user to be stored in the impact degree calculation rule information storing unit 32. The impact degree calculation rule information storing unit 32 stores in each entry an evaluation item 32a, a demand-supply condition 32b, a definition equation 32c, and a threshold 32d.

The evaluation item 32a is an item for which the degree of impact is calculated by the impact degree calculating unit 14. In the example of FIG. 10, articles and bases are items of the impact degree calculation.

The demand-supply condition 32b is a demand-supply condition about which the degree of impact is calculated by the impact degree calculating unit 14. In the example of FIG. 10, the impact degree calculating unit 14 calculates the degree of impact of an “article” on “initial stock”. More specifically, the impact degree calculating unit 14 calculates the degrees of impact of items that are grouped by the grouping unit 13 and items that are not grouped by the grouping unit 13 on “initial stock”. The impact degree calculating unit 14 in the example of FIG. 10 also calculates the degree of impact of a “base” on “production capacity”. More specifically, the impact degree calculating unit 14 calculates the degree of impact of a “factory” on “production capacity”.

The definition equation 32c is a calculus equation used by the impact degree calculating unit 14 to calculate the degree of impact. The definition equation 32c (M1, M2, M3) is defined in relation to the demand-supply condition 32b, and is expressed by Expressions (2) to (4).

$$\begin{matrix}[ Expression 2 ] & \\ M 1 = \frac{demanded quantity}{initial stock quantity} & ( 2 ) \\ [ Expression 3 ] & \\ M 2 = \{ \begin{matrix}0 & \begin{matrix}When the number of factories where a product ( products ) \\ can be maufactured is one\end{matrix} \\ 1 & \begin{matrix}When the number of factories where a product ( products ) \\ can be manufactured is two or more\end{matrix}\end{matrix} & ( 3 ) \\ [ Expression 4 ] & \\ M 3 = \frac{maximum load}{production capacity} & ( 4 )\end{matrix}$$

For example, the impact degree calculating unit 14 calculates by Expression (2) the degrees of impact of items that are grouped by the grouping unit 13 and items that are not grouped by the grouping unit 13 on a demand-supply condition “initial stock”. The impact degree calculating unit 14 calculates by Expression (3) the degrees of impact of items that are grouped by the grouping unit 13 and items that are not grouped by the grouping unit 13 on a demand-supply condition “production base selection”. The impact degree calculating unit 14 calculates by Expression (4) the degree of impact of a base on a demand-supply condition “production capacity”. Details of Expressions (2) to (4) are described below.

The threshold 32d is a threshold that the determining unit 15 uses to determine whether or not the demand-supply condition 32b is to be used in the logistics network search processing, based on the degree of impact calculated by the impact degree calculating unit 14. For example, when the degree of impact of a part (or a group of parts) on “initial stock” calculated by the impact degree calculating unit 14 does not exceed a threshold “1.0”, the determining unit 15 determines that the “initial stock” of the part is not to be used as a condition in the logistics network search.

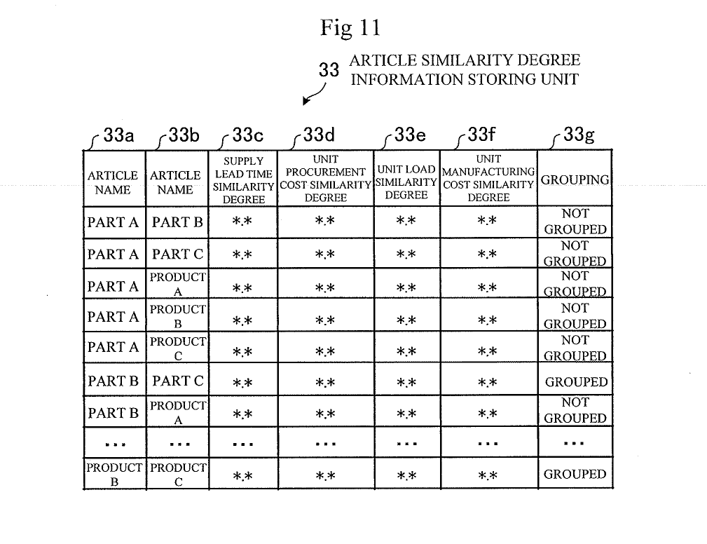

FIG. 11 is a diagram showing a data configuration example of the article similarity degree information storing unit 33. The article similarity degree information storing unit 33 stores information about the degree of similarity between articles and information about grouping. The information about the degree of similarity between articles is stored in the article similarity degree information storing unit 33 by the similarity degree calculating unit 12, and the information about grouping is stored in the article similarity degree information storing unit 33 by the grouping unit 13. The article similarity degree information storing unit 33 stores in each entry article names 33a and 33b, a supply lead time similarity degree 33c, a unit procurement cost similarity degree 33d, a unit load similarity degree 33e, a unit manufacturing cost similarity degree 33f, and grouping 33g.

The article names 33a and 33b are the names of articles for which the degree of similarity is calculated. In the example of FIG. 11, the degree of similarity between Parts A and B and the degree of similarity between Part A and Product A, for instance, are calculated.

The supply lead time similarity degree 33c is the degree of similarity between an article having the article name 33a and an article having the article name 33b from the viewpoint of supply lead time. For example, the similarity degree calculating unit 12 calculates by Expression (1) the degree of similarity between Parts A and B from the viewpoint of supply lead time (the supply lead time similarity degree 33c).

The unit procurement cost similarity degree 33d is the degree of similarity between the articles indicated by the article names 33a and 33b from the viewpoint of unit procurement cost. For example, the similarity degree calculating unit 12 calculates by Expression (1) the degree of similarity between Parts A and B from the viewpoint of unit procurement cost (the unit procurement cost similarity degree 33d).

The unit load similarity degree 33e is the degree of similarity between the articles indicated by the article names 33a and 33b from the viewpoint of unit load. For example, the similarity degree calculating unit 12 calculates by Expression (1) the degree of similarity between Parts A and B from the viewpoint of unit load (the unit load similarity degree 33e).

The unit manufacturing cost similarity degree 33f is the degree of similarity between the articles indicated by the article names 33a and 33b from the viewpoint of unit manufacturing cost. For example, the similarity degree calculating unit 12 calculates by Expression (1) the degree of similarity between Parts A and B from the viewpoint of unit manufacturing cost (the unit manufacturing cost similarity degree 33f).

The similarity degree calculating unit 12 calculates the degree of similarity for every combination of articles as shown in columns for the article names 33a and 33b.

The grouping 33g is information about the grouping of the articles indicated by the article names 33a and 33b. For example, a value “not grouped” in FIG. 11 indicates that the articles indicated by the article names 33a and 33b are not to be grouped together, and a value “grouped” indicates that the articles indicated by the article names 33a and 33b are to be grouped together.

When the supply lead time similarity degree 33c, the unit procurement cost similarity degree 33d, the unit load similarity degree 33e, and the unit manufacturing cost similarity degree 33f all exceed the threshold 31c (0.90) of FIG. 9, for example, the grouping unit 13 determines that the articles indicated by the article names 33a and 33b are to be grouped together, and stores the result of the determination (“grouped”) in the article similarity degree information storing unit 33 as the grouping 33g. In the example of FIG. 11, Part B and Part C are grouped together, and Product B and Product C are grouped together.

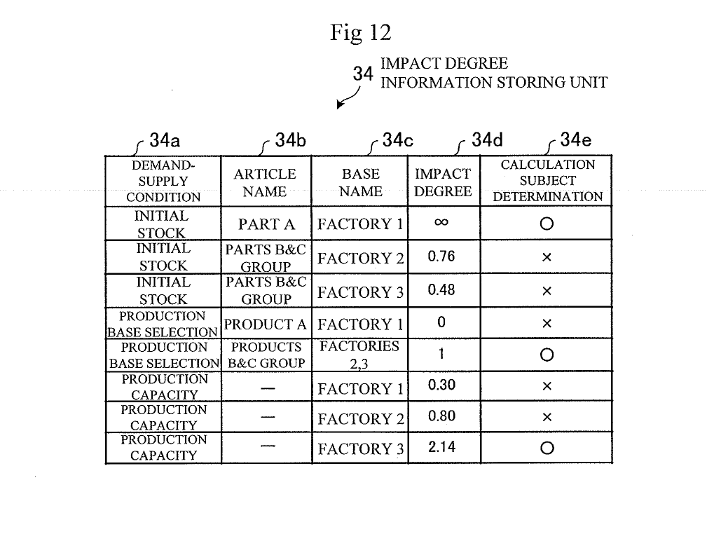

FIG. 12 is a diagram showing a data configuration example of the impact degree information storing unit 34. The impact degree information storing unit 34 stores information about the degree of impact of an article on a demand-supply condition, and information about the use of a supply-demand condition in the logistics network search processing. The information about the degree of impact of an article on a demand-supply condition is stored in the impact degree information storing unit 34 by the impact degree calculating unit 14, and the information about the use of a demand-supply condition in the logistics network search processing is stored in the impact degree information storing unit 34 by the determining unit 15. The impact degree information storing unit 34 stores in each entry a demand-supply condition 34a, an article name 34b, a base name 34c, an impact degree 34d, and calculation subject determination 34e.

The demand-supply condition 34a is a demand-supply condition about which the degree of impact is calculated.

The article name 34b is the article name of an article whose degree of impact is calculated. In the example of FIG. 12, the degree of impact of “Part A” on “initial stock” is calculated.

A value “−” of the article name 34b in an entry indicates that no article name 34b is stored in that entry of the impact degree information storing unit 34. For example, a value “production capacity” of the demand-supply condition 34a indicates the production capacity of a factory and, accordingly, no article name 34b is stored in association with “production capacity” in the impact degree information storing unit 34.

The base name 34c in an entry indicates the name of a base that has the initial stock of an article indicated by the article name 34b of the entry when the demand-supply condition 34a of the entry is “initial stock”. In the example of FIG. 12, the base name 34c of a base that has the initial stock of “Part A” is “Factory 1”. The base name 34c in an entry indicates the name of a base that manufactures an article indicated by the article name 34b of the entry when the demand-supply condition 34a of the entry is “production base selection”. In the example of FIG. 12, the base name 34c of a base where “Product A” is manufactured is “Factory 1”. The base name 34c in an entry indicates the name of a base and the production capacity of the base when the demand-supply condition 34a of the entry is “production capacity”.

The impact degree 34d is the degree of impact of the article indicated by the article name 34b on the demand-supply condition 34a at the base indicated by the base name 34c, which is calculated by the impact degree calculating unit 14. For example, the impact degree 34d of “Part A” on “initial stock” at “Factory 1” is infinite (“∞”).

The calculation subject determination 34e is information that indicates whether or not the demand-supply condition 34a of the article indicated by the article name 34b in the base indicated by the base name 34c is to be used in the logistics network search processing. For example, a circle (“∘”) in FIG. 11 indicates that the demand-supply condition 34a of an article indicated by the article name 34b is to be used in the logistics network search processing, and a cross (“x”) indicates that the supply-demand condition 34a of the article indicated by the article name 34b is not to be used in the logistics network search processing. More specifically, the demand-supply condition “initial stock” of “Part A” at “Factory 1” has a circle (“∘”) as the calculation subject determination 34e, and is therefore used in the logistics network search processing. The demand-supply condition “initial stock” of “Parts B&C group” at “Factory 2” has a cross (“x”) as the calculation subject determination 34e, and is therefore not used in the logistics network search processing.

The operation of the demand-supply adjusting device 1 is described with reference to a flow chart.

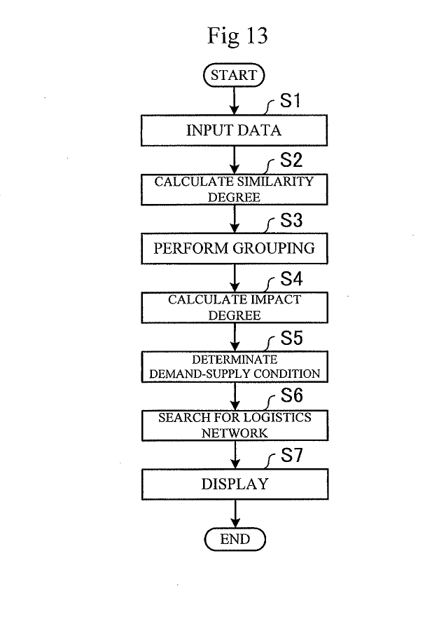

FIG. 13 is a flow chart illustrating an operation example of the demand-supply adjusting device 1. The demand-supply adjusting device 1 executes steps illustrated in FIG. 13 when, for example, the user issues a request to search for an optimum logistics network.

First, the input unit 11 receives information from the user (Step S1). The input unit 11 receives from the user an input of, for example, demand-supply information about demand and supply, information about similarity degree calculation, and information about impact degree calculation. The input unit 11 stores the information input by the user by storing the demand-supply information in the demand-supply information storing unit 20, storing the information about similarity degree calculation in the similarity degree calculation rule information storing unit 31, and storing the information about impact degree calculation in the impact degree calculation rule information storing unit 32.

Next, the similarity degree calculating unit 12 calculates the degree of similarity between items (here, between articles such as parts and products) that are included in the demand-supply information stored in the demand-supply information storing unit 20 (Step S2). The similarity degree calculating unit 12 stores the calculated degree of similarity in the article similarity degree information storing unit 33.

For example, the similarity degree calculating unit 12 calculates the degrees of similarity between articles that are selected from Parts A to C and Products A to C as shown in the columns for the article names 33a and 33b of FIG. 11. The similarity degree calculating unit 12 calculates the degrees of similarity between articles from viewpoints indicated by the evaluation parameters 31d of FIG. 9. Specifically, the similarity degree calculating unit 12 calculates the supply lead time similarity degree 33c, the unit procurement cost similarity degree 33d, the unit load similarity degree 33e, and the unit manufacturing cost similarity degree 33f.

The similarity degree calculating unit 12 uses Expression (1) (the definition equation 31b of FIG. 9) to calculate the degrees of similarity between articles from the respective viewpoints indicated by the evaluation parameters 31d. “Evaluation value” in Expression (1) is a value of an article that is defined as one of the evaluation parameters 31d in FIG. 9. For example, the degree of similarity between Part A and Part B from the viewpoint of supply lead time is calculated by Expression (1) as Expression (5).

$$\begin{matrix}[ Expression 5 ] & \\ degree of similarity between Part A and Part B = 1 - \frac{\sqrt{\frac{{( 1 - 0 )}^{2}}{{( max \{ 1 , 0 \} )}^{2}} + \frac{{( 0 - 3 )}^{2}}{{( max \{ 0 , 3 \} )}^{2}} + \frac{{( 0 - 3 )}^{2}}{{( max \{ 0 , 3 \} )}^{2}}}}{3} & ( 5 )\end{matrix}$$

“Base” in Expression (1) is a supplier in the case where the article is a part, and a factory in the case where the article is a product.

Next, the grouping unit 13 groups articles together based on the degrees of similarity calculated by the similarity degree calculating unit 12 (Step S3).

For example, when the degree of similarity between articles exceeds the threshold 31c from every one of viewpoints indicated by the evaluation parameters 31d of FIG. 9, the grouping unit 13 groups the articles together. More specifically, the grouping unit 13 groups together articles for which the supply lead time similarity degree 33c, unit procurement cost similarity degree 33d, unit load similarity degree 33e, and unit manufacturing cost similarity degree 33f of FIG. 11 all exceed the threshold 31c. In the example of FIG. 11, Parts B and C are grouped together, and Products B and C are grouped together. In the following description, articles grouped together by the grouping unit 13 for the purpose of consolidation may be referred to as “article group”. For instance, the grouped Parts B and C may be referred to as “Parts B&C group”, and the grouped Products B and C may be referred to as “Products B&C group”.

When articles are grouped for consolidation, the evaluation value of the group differs from the evaluation values of the individual articles. The grouping unit 13 calculates the evaluation value of consolidated articles (a group evaluation value) by Expression (6).

$$\begin{matrix}[ Expression 6 ] & \\ group evaluation value = \frac{{\sum }_{article} ( \begin{matrix}demanded quantity of article \times \\ evaluation value of article\end{matrix} )}{{\sum }_{article} demanded quantity of article} & ( 6 )\end{matrix}$$

For example, Product A includes a single Part A, Product B includes a single Part B, and Product C includes a single Part C. The demanded quantity of Part B is “8” according to FIG. 2 and the demanded quantity of Part C is “30” according to FIG. 2. The unit purchase price of the “Parts B&C group” at “Supplier 3” is therefore calculated by Expression (7) with the use of Expression (6).

$$\begin{matrix}[ Expression 7 ] & \\ unit purchase price = \frac{8 \times 28 + 30 \times 30}{38} = 29.6 & ( 7 )\end{matrix}$$

While the unit purchase price of Part B is “28” and the unit purchase price of Part C is “30” at Supplier 3 according to FIG. 4, the unit purchase price of the “Parts B&C group” (consolidated Parts B and C) (the group evaluation value) is calculated to be “36.3”. The other group evaluation values such as the unit manufacturing cost and the unit load can similarly be obtained by Expression (7).

The group evaluation value of Expression (6) is an average of the evaluation values of grouped articles that is weighted by demanded quantities. The group evaluation value is therefore not limited to Evaluation (6), and can be the maximum or minimum value among the evaluation values of grouped articles. The group evaluation value can also be a simple average of the articles' evaluation values.

Next, the impact degree calculating unit 14 calculates the degrees of impact of article groups that are created through grouping by the grouping unit 13 and articles that are not grouped by the grouping unit 13 on demand-supply conditions (Step S4). The impact degree calculating unit 14 stores the calculated degrees of impact in the impact degree information storing unit 34.

The impact degree calculating unit 14 calculates the degrees of impact of article groups and articles on, for example, the demand-supply condition “initial stock”. For example, the impact degree calculating unit 14 uses Expression (2) to calculate the impact degree 34d on the demand-supply condition 34a of FIG. 12 that is “initial stock”. The impact degree calculating unit 14 calculates the degrees of impact of article groups and articles on the demand-supply condition “production base selection”. For example, the impact degree calculating unit 14 uses Expression (3) to calculate the impact degree 34d on the demand-supply condition 34a of FIG. 12 that is “production base selection”. The impact degree calculating unit 14 calculates the degrees of impact of a production base of an article on the demand-supply condition “production capacity”. For example, the impact degree calculating unit 14 uses Expression (4) to calculate the impact degree 34d on the demand-supply condition 34a of FIG. 12 that is “production capacity”. A concrete description is given on those three types of impact degree calculation.

(1) Calculation of the Degrees of Impact of Article Groups and Articles on the Demand-Supply Condition “Initial Stock”

The impact degree calculating unit 14 calculates by Expression (2) the degrees of impact of article groups and articles on the demand-supply condition “initial stock” as described above.

For example, the demanded quantity of Part A is “25” (the demanded quantity 21d of Product A including Part A is “25” in FIG. 2) according to FIG. 2, and the initial stock quantity of “Part A” at “Factory 1” is “0” according to FIG. 8. The impact degree 34d of “Part A” on the demand-supply condition “initial stock” at “Factory 1” is therefore calculated by Expression (2) as infinite in FIG. 12.

The demanded quantity of the Parts B&C group is “38” (the demanded quantities of Product B including Part B and Product C including Part C is “38” in FIG. 2) according to FIG. 2, and the initial stock quantity of the “Parts B&C group” at Factory 2 is “50” according to FIG. 8. The impact degree 34d of “Parts B&C group” on the demand-supply condition “initial stock” at “Factory 2” is therefore calculated by Expression (2) as “0.76” in FIG. 12.

(2) Calculation of the Degrees of Impact of Article Groups and Articles on the Demand-Supply Condition “Production Base Selection”

The impact degree calculating unit 14 calculates by Expression (3) the degrees of impact of article groups and articles on the demand-supply condition “production base selection” as described above.

For example, Product A is manufactured at only one place, “Factory 1”, according to FIG. 5, and the impact degree 34d of “Product A” on the demand-supply condition “production base selection” at “Factory 1” is therefore calculated by Expression (3) as “0” in FIG. 12. The Products B&C group is manufactured at two places, “Factory 2” and “Factory 3”, according to FIG. 5, and the impact degree 34d of the “Products B&C group” on the demand-supply condition “production base selection” at “Factories 2 and 3” is therefore calculated by Expression (3) as “1” in FIG. 12.

(3) Calculation of the Degree of Impact of a Production Base on the Demand-Supply Condition “Production Capacity”

The impact degree calculating unit 14 calculates by Expression (4) the degree of impact of a production base on the demand-supply condition “production capacity” as described above.

For example, the unit load of Product A is “1” in FIG. 6. A date at which the load is maximum (a date at which the demanded quantity is the largest) for Product A is “Sep. 11, 2014” according to FIG. 2, and the demanded quantity of “Product A” on “Sep. 11, 2014” is “15” in FIG. 2. The maximum load of “Product A” is therefore “15”×“1”=“15”. The production capacity of “Factory 1” is “50” according to FIG. 7. The impact degree 34d of “Product A” on the demand-supply condition “production capacity” at “Factory 1” is therefore calculated by Expression (4) as “0.30” in FIG. 12. In the case where the production capacity of Factory 1 varies depending on the production date 26b, for example, from “50” to “70” to “40”, the production capacity used in Expression (4) is the smallest production capacity (the severest condition), here, “40”.

The unit load of the “Products B&C group”, which is created by consolidating Products B and C, is calculated by Expression (6), which is for calculating a group evaluation value, as “2.8”. A date at which the load is maximum (a date at which the demanded quantity is the largest) for the “Products B&C group” is “Sep. 12, 2014” according to FIG. 2, and the demanded quantity of the “Products B&C group” on “Sep. 12, 2014” is “23” according to FIG. 2. The maximum load of the “Products B&C group” is therefore “23”×“2.8”=“64.4”. The production capacity of “Factory 2” is “80” according to FIG. 7. The impact degree 34d of “Factory 2” on the demand-supply condition “production capacity” when products of the “Products B&C group” are manufactured is therefore calculated by Expression (4) as “0.81” in FIG. 12. In the case where the production capacity of Factory 2 varies depending on the production date 26b, for example, from “80” to “70” to “90”, the production capacity used in Expression (4) is the smallest production capacity (the severest condition), here, “70”.

Next, the determining unit 15 determines whether or not demand-supply conditions of article groups and articles are to be used in calculation for logistics network search processing, based on the degrees of impact calculated by the impact degree calculating unit (Step S5). The determining unit stores the results of the determination (the calculation subject determination 34e) in the impact degree information storing unit 34.

For example, when the impact degree 34d of the demand-supply condition “initial stock” in FIG. 12 does not exceed a value “1” of the threshold 32d in FIG. 10, it can be said that the factory in question has a plenty of parts in initial stock, and the factory can bring out the parts in initial stock for the manufacturing of the product. The determining unit 15 accordingly determines that the demand-supply condition “initial stock” of an article whose impact degree does not exceed the threshold 32d is not to be used in the logistics network search processing. The determining unit 15 also determines that the demand-supply condition “initial stock” is not to be used in the logistics network search processing upstream of a base of the article determined as an article to be excluded from the logistics network search processing. For instance, when determining that the demand-supply condition “initial stock” of Factories 2 and 3 is not to be used in the logistics network search processing, the determining unit 15 determines also for Suppliers 2 and 3, which are upstream of Factories 2 and 3, that the demand-supply condition “initial stock” is not to be used.

In the case of Product A, which has a value “0” as the impact degree 34d with respect to the demand-supply condition “production base selection”, for example, the determining unit 15 subtracts from the production capacity and stocked parts of Factory 1 a capacity and a quantity that are necessary to produce Product A, and determines that the demand-supply condition “production base selection” of Product A is not to be used in the logistics network search processing.

In the case of the demand-supply condition “production capacity” of Factories 1 and 2 in FIG. 12, for example, the determining unit 15 regards the production capacity of Factories 1 and 2 as infinite, and determines that the demand-supply condition “production capacity” of Factories 1 and 2 is not to be used in the logistics network search processing.

Next, the demand-supply adjusting unit 16 searches for an optimum logistics network with the use of demand-supply conditions determined by the determining unit 15 as conditions to be used in calculation for the logistics network search processing, and calculates the flow volume of the found logistics network (Step S6). For example, the demand-supply adjusting unit 16 refers to the calculation subject determination 34e of FIG. 12 to identify demand-supply conditions that are to be used in the calculation, searches for an optimum logistics network, and calculates the flow volume of the found logistics network.

Next, the display unit 17 displays on the display device the result of the determination performed by the determining unit 15. The display unit 17 also displays the logistics network found by the demand-supply adjusting unit 16 and the flow volume thereof on the display device (Step S7). The processing of this flow chart is then ended.

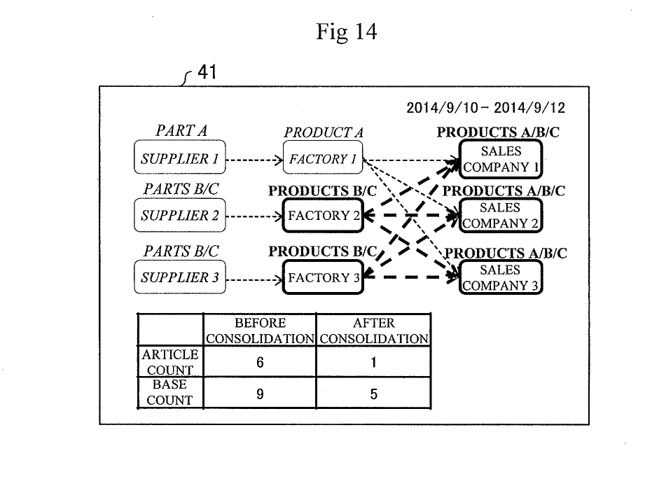

FIG. 14 is a diagram illustrating an example of a screen that displays the result of the determination performed by the determining unit 15. The screen of FIG. 14 is denoted by 41 and displayed on the display device by the display unit 17.

In the example of the screen 41, the display unit 17 displays articles consolidated by grouping and bases consolidated by grouping in normal type and with the use of thick lines. The display unit 17 displays unconsolidated articles and unconsolidated bases in italic type and with the use of thin lines.

The display unit 17 also displays article counts and base counts before and after consolidation. In the example of the screen 41, the pre-consolidation article count is six (Parts A to C and Products A to C), and the post-consolidation article count is one (the Products B&C group). The pre-consolidation base count is nine (Suppliers 1 to 3, Factories 1 to 3, and Sales Companies 1 to 3), and the post-consolidation base count is five (Factories 2 and 3 and Sales Companies 1 to 3). Because the demand-supply condition “initial stock” of the “Parts B&C group” at Factories 2 and 3 is not used in the processing of searching for an optimum logistics network in the example of FIG. 12, the demand-supply condition “initial stock” of the “Parts B&C group” at Suppliers 2 and 3, which are upstream of Factories 2 and 3, is not used in the processing of searching for an optimum logistics network.

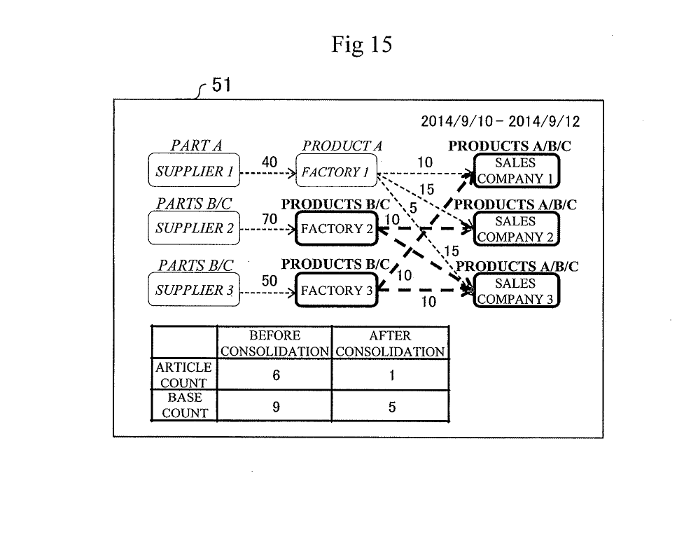

FIG. 15 is a diagram illustrating an example of a screen that displays a logistics network found by the demand-supply adjusting unit 16 and flow volumes calculated by the demand-supply adjusting unit 16. The screen of FIG. 15 is denoted by 51 and displayed on the display device by the display unit 17.

The screen 51 displays an optimum logistics network as opposed to the screen 41 of FIG. 14. For example, while the screen 41 of FIG. 14 display all possible logistics network paths as indicated by dotted-line arrows, the screen 51 displays an optimum logistics network path. The screen 51 also displays the flow volumes of articles on the optimum logistics network path as opposed to the screen 41 of FIG. 14.

A hardware configuration example of the demand-supply adjusting device 1 is described.

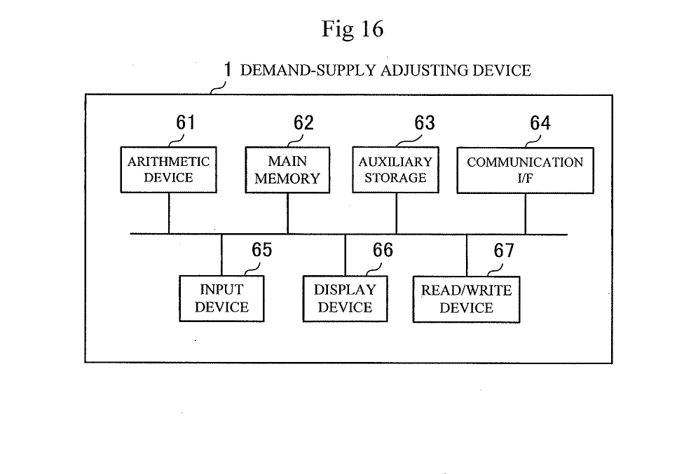

FIG. 16 is a diagram illustrating a hardware configuration example of the demand-supply adjusting device 1.

The demand-supply adjusting device 1 can be implemented by a computer that includes, for example, components illustrated in FIG. 16: an arithmetic device 61 such as a central processing unit (CPU), a main memory 62 such as a random access memory (RAM), an auxiliary storage 63 such as a hard disk drive (HDD), a communication interface (I/F) 64 for connecting to a communication network by wired or wireless connection, an input device 65 such as a mouse, a keyboard, a touch sensor, or a touch panel, a display device 66 such as a liquid crystal display, and a read/write device 67 for reading/writing information in a portable storage medium such as a digital versatile disc (DVD).

The functions of the units illustrated in FIG. 1 are implemented by, for example, the arithmetic device 61 by executing a given program that is loaded onto the main memory 62 from the auxiliary storage 63 or other places. The input unit 11 is implemented by, for example, the arithmetic device 61 by using the input device 65. The display unit 17 is implemented by, for example, the arithmetic device 61 by using the display device 66. The storing units of FIG. 1 are implemented by, for example, by the arithmetic device 61 by using the main memory 62 or the auxiliary storage 63.

The given program may be installed from, for example, a storage medium read by the read/write device 67, or may be installed from a network via the communication I/F 64.

In the manner described above, the similarity degree calculating unit 12 of the demand-supply adjusting device 1 calculates the degree of similarity between items that are included in the demand-supply information stored in the demand-supply information storing unit 20, and the grouping unit 13 groups together the items included in the demand-supply information based on the degree of similarity calculated by the similarity degree calculating unit 12. The impact degree calculating unit 14 calculates the degrees of impact of items that are grouped by the grouping unit 13 and items that are not grouped by the grouping unit 13 on demand-supply conditions to be used in processing of searching for an optimum logistics network. The determining unit 15 determines whether or not the demand-supply conditions are to be used in the logistics network search processing based on the degrees of impact calculated by the impact degree calculating unit 14. The demand-supply adjusting device 1 can thus obtain a logistics network that is optimum under consolidated demand-supply conditions.

The demand-supply adjusting device 1, which is capable of obtaining a logistics network that is optimum under consolidated demand-supply conditions, also does not need to execute simulation to determine whether or not demand-supply conditions before consolidation are fulfilled by an optimum logistics network obtained.

In addition, the display unit 17 displays on the display device 66 the result of the determination performed by the determining unit 15 and an optimum logistics network, thereby enabling the user to grasp an article and a base that are a bottleneck in a demand-supply adjustment by viewing the display device 66, and to solve the bottleneck efficiently.

The demand-supply adjusting device 1 may return to Step S2 after Step S5. For example, the similarity degree calculating unit 12 may calculate the degree of similarity between items whose demand-supply condition has been determined by the determining unit 15 (in Step S5) as a condition to be used in the logistics network search processing (Step S2). Demand-supply conditions can be consolidated further in this manner.

The similarity degree calculating unit 12, which calculates the degree of similarity between articles such as parts and products in the description given above, can calculate the degree of similarity between bases for supplying or manufacturing articles as well. For instance, the similarity degree calculating unit 12 can calculate the degree of similarity also when the evaluation item 31a of FIG. 9 is a “base”. More specifically, the similarity degree calculating unit 12 calculates how similar Base X and Base Y, which supply parts, are to each other. The evaluation parameter 31d that is used in this case is the production capacities of the bases.

The impact degree calculating unit 14, which calculates the degree of impact on a factory's production capacity in the description given above, may calculate the degree of impact on a supplier's supply capacity.

The demand-supply conditions of items for which the degrees of impact are calculated are not limited to “initial stock”, “production base selection”, and “production capacity” given above.

The present invention is not limited to the embodiment described above and covers various modification examples. For instance, the embodiment described above is a detailed description written for an easy understanding of the present invention, and the present invention is not necessarily limited to a configuration that includes all of the described components. The configuration of one embodiment may partially be replaced by the configuration of another embodiment. The configuration of one embodiment may be joined by the configuration of another embodiment. In each embodiment, apart of the configuration of the embodiment may have another configuration added thereto or removed therefrom, or may be replaced by another configuration.

Some of or all of the configurations, functions, processing units, processing means, and the like described above may be implemented by hardware by, for example, designing those as an integrated circuit. The configurations, functions, and the like described above may be implemented by software through a processor's interpretation and execution of programs for implementing the respective functions. The programs for implementing the functions and information such as tables and files can be put in a memory, in a recording device such as a hard disk or a solid state drive (SSD), or in a storage medium such as an IC card, an SD card, or a DVD. The present invention can be provided also as a demand-supply condition consolidating method in the demand-supply adjusting device 1, as a program for implementing the demand-supply condition consolidating method in the demand-supply adjusting device 1, and as a storage medium having the program stored thereon.

What is claimed is:

1. A demand-supply adjusting device, comprising:
a demand-supply information storing unit configured to store demand-supply information about demand and supply;
a similarity degree calculating unit configured to calculate a degree of similarity between items that are included in the demand-supply information stored in the demand-supply information storing unit;
a grouping unit configured to group the items included in the demand-supply information together, based on the degree of similarity calculated by the similarity degree calculating unit;
an impact degree calculating unit configured to calculate, for items that are grouped by the grouping unit and for items that are not grouped by the grouping unit, degrees of impact of the items on demand-supply conditions to be used in processing of searching for an optimum logistics network; and
a determining unit configured to determine, based on the degrees of impact calculated by the impact degree calculating unit, whether or not the demand-supply conditions of the items are to be used in the logistics network search processing.

2. A demand-supply adjusting device according to claim 1, wherein, when the degree of similarity between items exceeds a given threshold, the grouping unit groups the items together.

3. A demand-supply adjusting device according to claim 1, wherein, when the degrees of impact of the items on the demand-supply conditions exceed a given threshold, the determining unit determines that the demand-supply conditions of the items are to be used in the logistics network search processing.

4. A demand-supply adjusting device according to claim 1, wherein the similarity degree calculating unit calculates the degree of similarity between items included in the demand-supply information from viewpoints of a plurality of evaluation parameters.

5. A demand-supply adjusting device according to claim 4, wherein the grouping unit groups the items together when the degree of similarity between the items exceeds a given threshold in every one of the plurality of evaluation parameters.

6. A demand-supply adjusting device according to claim 1, wherein the similarity degree calculating unit calculates the degree of similarity between items of the demand-supply conditions that are determined by the determining unit as conditions to be used in the logistics network search processing.

7. A demand-supply adjusting device according to claim 1, further comprising a display unit configured to display a result of the determination performed by the determining unit.

8. A demand-supply adjusting device according to claim 1, further comprising:
a demand-supply adjusting unit configured to use the demand-supply conditions determined by the determining unit to search for the logistics network, and calculate a flow volume on the logistics network; and
a display unit configured to display the logistics network found by the demand-supply adjusting unit and the flow volume on the logistics network.

9. A demand-supply adjusting device according to claim 1, wherein the items whose degree of similarity is calculated by the similarity degree calculating unit comprise one of: articles; and bases.

10. A demand-supply condition consolidating method to be performed by a demand-supply adjusting device, comprising:
calculating, by the demand-supply adjusting device, a degree of similarity between items that are included in demand-supply information about demand and supply, which is stored in a demand-supply information storing unit;
grouping, by the demand-supply adjusting device, the items included in the demand-supply information together, based on the degree of similarity calculated in the calculating of the degree of similarity;
calculating, by the demand-supply adjusting device, for items that are grouped in the grouping and for items that are not grouped in the grouping, degrees of impact of the items on demand-supply conditions to be used in processing of searching for an optimum logistics network; and
determining, by the demand-supply adjusting device, based on the degrees of impact calculated in the calculating of the degrees of impact, whether or not the demand-supply conditions of the items are to be used in the logistics network search processing.
